(19) United States
(12) Patent Application Publication
(10) Pub. No.: US 2015/0249275 A1
(43) Pub. Date: Sep. 3, 2015

(54) STORAGE BATTERY STRUCTURE

(71) Applicant: Hsueh-Hung HUANG, New Taipei City (TW)

(72) Inventor: Hsueh-Hung HUANG, New Taipei City (TW)

(21) Appl. No.: 14/193,401

(22) Filed: Feb. 28, 2014

(51) Int. Cl. H01M 10/42

(52) U.S. Cl. CPC H01M 10/4235

(57) ABSTRACT

A storage battery structure assembled from positive plates, negative plates, plates, a battery compartment, an electrolyte, wiring portions, and a plurality of microelement structures disposed in the bottom portion of the battery compartment. Each of the microelement structures enable the battery structure to produce highfield activated molecular vibration frequencies, thereby changing the molecular structure of the electrolyte to achieve accelerated ionic exchange rates, accelerated charging times, increased conversion rates, reduced accumulating blockage of lead sulfate crystals, reduced corrosion rate of the positive plates, and extended battery life.

### BACKGROUND OF THE INVENTION

(a) Field of the Invention

The present invention relates to a storage battery structure able to accelerate the charging speed, increase the conversion rate, reduce the accumulated blockage of lead sulfate crystals, reduce the corrosion rate of the positive plate, and extend the service life of the battery, thereby achieving the environmental objective of reducing wastage of natural resources, providing green energy, and reducing carbon emissions.

(b) Description of the Prior Art

As is well known, natural minerals such as granite, zeolite and meng moli pumice all provide a positive ion exchange effect or the capacity to use far infrared rays to produce a non-thermal effect. Furthermore, metals such as silver and copper have the capacity to provide a bactericidal effect and the capacity of conductivity. The far infrared rays and positive ions produced by coal and charcoal (such as activated charcoal, hard charcoal, and bamboo charcoal) have the function of deodorization, and increase the activation of stored energy.

In terms of material improvements, only among the aforementioned effects including negative ion effect, far-infrared effect, deodorizing effect, and positive ion exchange effect is specific effectiveness achieved by traditional storage batteries. And the materials are all mixtures of single materials, such as natural minerals, ceramic, coal, charcoal, metal, and other materials, that have been processed and blended together. As identified by empirical methods, generally speaking, the effectiveness produced by single materials must be generated gradually through the accumulation of time.

On the contrary, various inventions of the prior art have mixed ceramic and natural stones or mixed various kinds of original stones, such as maifan stone, nuwa stone, and the like, to manufacture materials that bring into full play the complementary and synergistic effectiveness of the functions of those single materials. However, in reality, the inventions disclosed by the prior art can not be said to be inventions having characteristics able to complement the target material requiring to be modified and bring the most effective features into full play.

In addition, traditional improved materials involve independent processing of natural minerals, ceramic, coal, charcoal, and other materials, and are similar to modified materials made from a combination of many different substances. All these materials directly contact the target material requiring improvement. However, if the natural minerals, ceramic, coal, charcoal, and the like, have impurities and foreign substances that dissolve and separate out, then such materials are far from being perfect from a safety aspect. Because every metal material has its own characteristics, thus, when combined with natural minerals, if no long term experiments have been carried out to accumulate changes therein, then such materials are not suitable for use in modifying materials.

Thus it can be seen that the aforementioned changes in the quality of materials of the prior art still have many shortcomings, and in reality are not good designs. Hence, there is still an urgent need for improvement.

### SUMMARY OF THE INVENTION

The main objective of the present invention lies in disposing microelement structures in the bottom portion of a battery compartment, thereby modifying the molecular structure of the electrolyte, and achieving an accelerated ion exchange rate, which enables accelerating charging time, increasing conversion rate, reducing the accumulating blockage of lead sulfate crystals, reducing the corrosion rate of the positive plate, and extending the service life of the battery. With such a design, the present invention is further able to reduce polluting the earth, reduce wastage of natural resources, and achieve the environmental objective of providing green energy and reducing carbon emissions.

In order to achieve the aforementioned objective, the structure of the present invention is assembled from positive plates, negative plates, plates, a battery compartment, an electrolyte, and wiring portions. Wherein the positive plates and the negative plates are respectively disposed at positions on two sides of the plates. Moreover, a distance is preserved between an inner wall bottom portion of the battery compartment and the positive plates, the negative plates, and the plates. The microelement structures are disposed in the bottom portion of the battery compartment, and each of the microelement structures is made up from a mixture of a granite powder layer, a tourmaline powder layer, and at least one stone powder layer, and then formed through mold casting and high temperature sintering.

The structural composition of the natural minerals, metals, charcoal, coal, and the like were analyzed using X-ray fluorescence analysis. Next, X-ray fluorescence analysis was again used to analyze the crystal structure of the various aforementioned materials. Then MRA (magnetic resonance analysis) was used to electromagnetically analyze the quality of the various substances to examine the optimum composition of each of the aforementioned materials. After selection of each of the above materials, the preferred combination was based on granite and tourmaline. As for the optimal mixing ratio of these two materials, a MRA was used to examine codes such as far infrared, deodorization, negative ions, natural cosmic energy storage and release capability, and high and low vibration frequencies. A decision was then made after measuring the size of cluster groups (size of Hz (hertz)).

In order to achieve effective application of the modified material, it was cast molded into different shapes, and then sintered at high temperature to form different shapes for use thereof.

Another objective of the present invention lies in using the structure of the present invention in combination with the microelement structures to achieve effects including effectively reducing impedance, lowering the self-discharge rate, providing resistance to over-discharge, and enabling a fast charging speed, as well as providing a long cycle life, good low temperature capacity performance, good high rate discharge properties, and good high-current output properties.

A further objective of the present invention lies in substantially reducing the daily amount of sewage produced during the manufacturing process of the present invention, which is less than 20 tons—much lower than the up to 300 tons of sewage discharge produced during the manufacturing process of current products, and better conforms to the demands of environmental protection.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a cross-sectional schematic view of a storage battery structure of the present invention.

FIG. 2 is a partial cross-sectional structural schematic view of a battery compartment of the present invention.

FIG. 3 is a cross-sectional structural schematic view of microelement structures of the present invention.

### DETAILED DESCRIPTION OF THE PREFERRED EMBODIMENTS

In order for the aforementioned objectives, features and advantages of the present invention to be clearly and easy to understand, the preferred embodiments disclosed in the present invention, with the accompanying drawings, are described in detail below.

Current storage batteries, also known as lead-acid storage batteries, are one type of battery with the electrodes primarily made of lead. Another type of storage battery has an electrolyte of sulfuric acid solution. In general, a storage battery comprises positive plates, negative plates, separating plates, a battery compartment, an electrolyte, and wiring portions. The positive plates are lead dioxide (PbO₂) plates, and the negative plates are lead (Pb) plates. The battery casing and upper cover are made from ABS (acrylonitrile butadiene styrene) synthetic resin, which has excellent resistance to being struck, as well as being nonflammable. The positive and negative plates are made from a corrosion resistant lead-calcium-tin alloy material, which will not release any harmful substances and deposit them on the negative plates, thus extending the service life of the battery. The positive and negative plates are both pasted lead plates, and glass wool made from liquid-absorbent fine fiberglass is used for the separating plates between the positive and negative plates. Connecting portions are contacts between the positive and negative plates and between the polar group, and use lead connections formed as an integral body, thereby significantly reducing the internal resistance of the battery and improving the high-rate discharge properties. Dilute sulfuric acid is also used as an electrolyte, a moderate amount of fluid being used, and does not contain other free fluids.

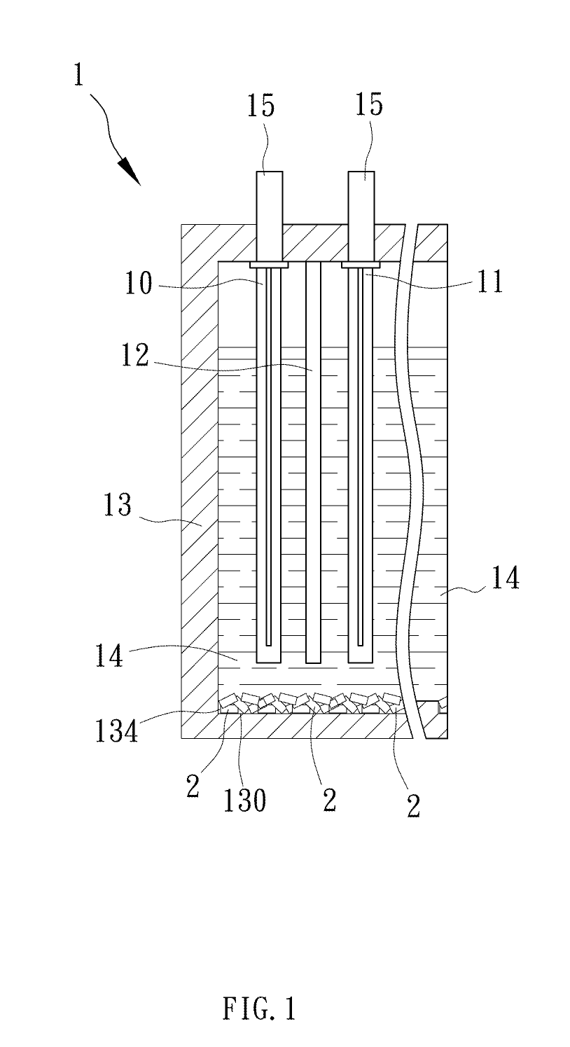

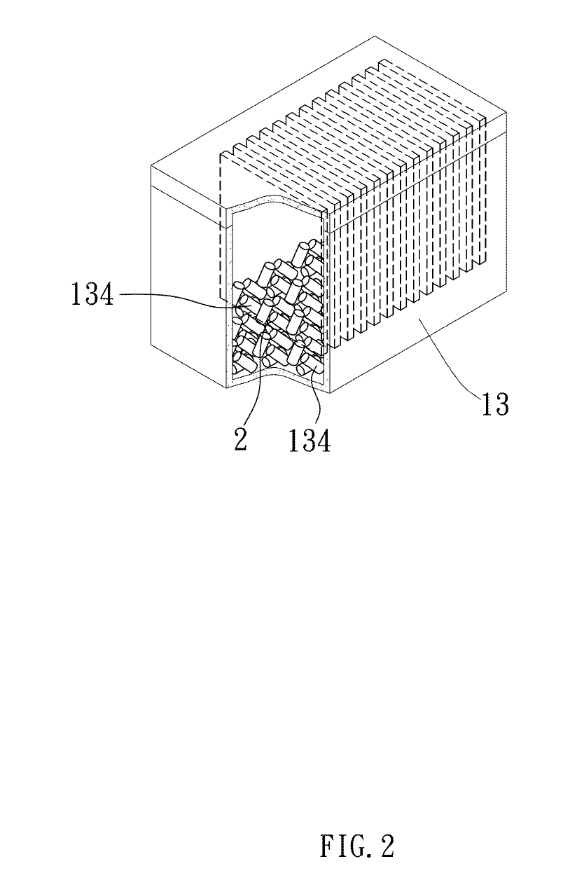

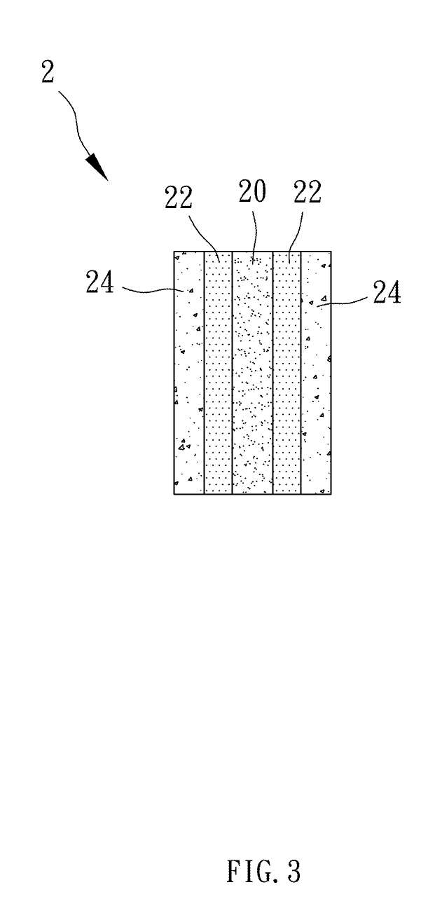

Referring to FIGS. 1 and 2, which respectively show a cross-sectional schematic view of a storage battery structure and a partial cross-sectional structural schematic view of a battery compartment of the present invention. The present invention relates to a storage battery structure, in which the storage battery 1 comprises positive plates 10, negative plates 11, plates 12, a battery compartment 13, an electrolyte 14, and wiring portions 15. Wherein the positive plates 10 and the negative plates 11 are respectively located on two sides of the plates 12, moreover, a distance is preserved between an inner wall bottom portion 130 of the battery compartment 13 and the positive plates 10, the negative plates 11, and the plates 12. Microelement structures 2 are disposed in the bottom portion 130 of the battery compartment 13. The microelement structures 2 are formed from a composition of a granitic layer 20, tourmaline layers 22, and at least one stone layer 24 (see FIG. 3), which is then mold casted and then sintered at high temperature.

The following characteristics of the storage battery, including discharging, charging, and service life characteristics are described below:

Regarding the discharging characteristics: The discharge capacity depends on the discharge current (discharge rate), with different discharge currents producing varying discharge capacities. The smaller the discharge current is, the greater the discharge capacity will be, or the greater the discharge current is, the smaller the discharge capacity will be. In addition, there are also differences in discharge capacity due to different temperatures. The lower the battery temperature is, the smaller the discharge capacity will be.

Regarding the charging characteristics: The charging voltage is intended to replenish the self-discharge of the battery to maintain a charged state. In order to avoid shortening the battery life due to charging, the value of this charging voltage is made as small as possible.

Regarding the service life characteristics: Factors affecting the float charge service life of the battery include the number of battery discharges, discharge temperature, float charging voltage, and the ambient temperature when the battery is in use.

The corrosion rate of the positive plates are temperature related. The higher the temperature is, the faster the corrosion will be. The shorter the float charge service life and the greater the floating charge current is, the faster the corrosion will be. Hence, an appropriate charging voltage is very important for carrying out float charging.

Because the majority of current storage batteries have lead dioxide (PbO₂) as the positive plates and lead (Pb) as the negative plates, “redox” (reduction-oxidation) causes deposition of some oxides having conductive properties during the process of charging and discharging. And the problem of sulfurization on the negative plates causes complications, with an accumulated covering of lead sulfate crystals causing a reduction in the area of chemical reaction. This leads to circuit blockage, which results in the inability to produce ion exchange, leading to the storage battery only having a short service life of 1 to 2 years. 80% of lead-acid batteries are discarded mainly because of sulfurization problems. In fact, this problem can be repaired to enable continued use of the battery by using high-tech technology to modify the material, and by taking preventive measures, enabling the service life of the battery to be extended to 5-6 years.

Magnetic resonance analysis (MRA) was effectively used to achieve the most suitable composite vibration frequency for modifying the target material. And it was determined by assessment based on values obtained from MRA that granite not only has an extremely strong far-infrared effect and a negative ion effect, moreover, it has the excellent ability to store natural cosmic energy. Furthermore, granite is able to modify the water quality of tap water, and the like, and turn it into mineral water, or micromolecular high-energy water using ultra-high vibration frequency. In addition, apart from having a powerful negative ion effect, tourmaline also has the function to accelerate ion exchange and stabilize hydrogen ions and oxygen ions. As for coal and charcoal, apart from having a very strong far infrared effect, a negative ion effect, and an antibacterial effect, they also have an excellent deodorizing function, the ability to store energy, and an absorption function. Zeolite, in addition to having a very strong far infrared effect, an antibacterial effect, and a positive ion exchange effect, it also has the ability to store natural cosmic energy effect. Meng moli pumice was confirmed to have excellent far-infrared effect, a negative ion effect, and a positive ion exchange effect, it also has the ability to release natural cosmic energy. Silver was confirmed to have excellent antibacterial effect, and a bactericidal effect. In addition, malachite has the function to store natural cosmic energy, and also has the function to accelerate ion exchange. Malachite and gypsum are able to effectively reduce the temperature during charging, and accelerate the ion exchange rate. Talcum powder has a far infrared effect,

In order to achieve the most suitable composite vibration frequency for modifying the target material (modifying the material function), MRA was used again to analyze the quality of various substances using electromagnetism, and examine the optimum composition of each of the aforementioned materials.

In order to achieve an improvement in the speed of ion exchange inside the storage battery to accelerate the charging time, reduce internal resistance, lower the accumulating blockage of lead sulfate crystals, reduce the corrosion rate of the positive plate, and extend the service life of the battery, selection of each of the aforementioned materials was based on the optimum combination of granite and tourmaline. As for the optimal mixing ratio of these two materials, this was decided after MRA was used to examine the codes including far infrared, deodorization, negative ions, natural cosmic energy storage, discharge function, and high and low vibration frequencies, as well as measuring the size of the cluster group (magnitude of Hz).

An analytical method was used employing NMR (Nuclear Magnetic Resonance) to measure the cluster groups, and it was found that the optimal composition was approximately: 70-80% by weight of granite, and in the range of 10-15% by weight of tourmaline. Next, apart from selecting the 70-80% by weight of granite, and 10-15% by weight of tourmaline, MRA was similarly used to determine the optimal composition of each of the other materials, and the optimum composition was: 6-8% by weight of charcoal, (here hard charcoal was used), 3-10% by weight of zeolite, and 0-3% by weight of silver. Wherein, 75% by weight of granite, and 12% by weight of tourmaline was the basic combination that achieved the most significant results, and second to that was the mixing ratio of charcoal, zeolite, and silver.

After measurements were carried out, it was found that the microelement structures 2 primarily formed from a mixed composition of powders of granite and tourmaline, and some stone material. The stone material was coal or charcoal or malachite or zeolite or feldspar or meng moli pumice or limestone or gypsum or talcum powder or silver, or a combination of the above materials.

In order to learn from practical tests that the present invention was able to achieve accelerating the ion exchange rate, tests were first carried out without the addition of the microelement structures 2. The relevant test data is provided in Table I, Table 2 and Table 3;
(1) Table 1, room temperature of 22 degrees C. (no added microelement structures):

| | | No | | | | | |
|---|---|---|---|---|---|---|---|
| | Charging | addition | | | | | |
| | time | First | Second | Third | Fourth | Fifth | Sixth |
| | (minutes) | polar | polar | polar | polar | polar | polar |
| | 10 | 30.3 | 31.9 | 32.5 | 32.7 | 32.8 | 32.2 |
| | 20 | 30.8 | 32.2 | 33 | 33.2 | 32.8 | 32.4 |
| | 40 | 31.1 | 32 | 33.1 | 32.9 | 32.5 | 31.4 |
| | 60 | 31.4 | 31.4 | 32.5 | 32.4 | 31.8 | 30.7 |
| | 80 | 31.8 | 33.6 | 33.8 | 34 | 33.9 | 32 |
| | 100 | 32.7 | 33.8 | 34.5 | 34.3 | 34.5 | 33.7 |
| | 120 | 34.1 | 35.4 | 35.8 | 36.2 | 35.9 | 34.6 |
| | 140 | | | | | | |
| | 150 | | | | | | |
| Temperature | 13.83 | 12.1 | 13.4 | 13.8 | 14.2 | 13.9 | 12.6 |
| rise | | | | | | | |
| | Average | | | | | | |

(2) Table 2 provides relevant data with the addition of the microelement structures at a room temperature of 18 degrees C. (added 0.06 g/Ah (ampere-hour) charge)

| | Charging | | | | | | |
|---|---|---|---|---|---|---|---|
| | time | First | Second | Third | Fourth | Fifth | Sixth |
| | (minutes) | polar | polar | polar | polar | polar | polar |
| | 10 | 23.3 | 22.8 | 22.4 | 22.9 | 23.5 | 23.8 |
| | 20 | 24.6 | 23.7 | 23.5 | 23.3 | 23.8 | 24.8 |
| | 40 | 25.7 | 25.6 | 25.1 | 24.9 | 25.6 | 25.7 |
| | 60 | 26.9 | 26.6 | 26.1 | 25.9 | 26.6 | 26.6 |
| | 80 | 28.5 | 28.5 | 28.3 | 28.4 | 28.6 | 28.3 |
| | 100 | 27.9 | 28.7 | 28.6 | 28.7 | 28.7 | 28.7 |
| | 120 | 28.7 | 29.1 | 28.9 | 29.2 | 28.6 | 29.0 |
| | 140 | 27.6 | 28.8 | 28.9 | 29 | 29.4 | 29.3 |
| | 150 | 27.5 | 28.5 | 28.5 | 28.8 | 29.2 | 28.7 |
| Temperature | 10.92 | 10.7 | 11.1 | 10.9 | 11.2 | 10.6 | 11.0 |
| rise | | | | | | | |
| | Average | | | | | | |

(3) Table 3, room temperature of 19 degrees C. (added 0.15 g/Ah)

| | Charging | | | | | | |
|---|---|---|---|---|---|---|---|
| | time | First | Second | Third | Fourth | Fifth | Sixth |
| | (minutes) | polar | polar | polar | polar | polar | polar |
| | 10 | 19.2 | 19.3 | 19.2 | 19.4 | 19.2 | 19.3 |
| | 20 | 19.3 | 19.6 | 19.7 | 19.6 | 19.8 | 19.8 |
| | 40 | 21.2 | 21.5 | 21.2 | 21.5 | 22.1 | 22.2 |
| | 60 | 22.5 | 22.4 | 22.7 | 22.1 | 22.9 | 22.6 |
| | 80 | 22.8 | 23.9 | 24.1 | 24.3 | 23.6 | 22.8 |
| | 100 | 23.5 | 24.5 | 24.9 | 24.7 | 24.4 | 23.4 |
| | 120 | 24.7 | 24.9 | 25.0 | 25.1 | 24.9 | 24.6 |
| | 140 | 23.6 | 24.5 | 24.5 | 24.4 | 24.6 | 23.6 |
| | 150 | 23.1 | 24.1 | 23.9 | 24.2 | 24.0 | 23.2 |
| Temperature | 5.87 | 5.7 | 5.9 | 6.0 | 6.1 | 5.9 | 5.6 |
| rise | | | | | | | |
| | Average | | | | | | |

In conclusion, from the above test data, it can be clearly seen that by adding more of the microelement structures of the present invention a corresponding faster charging time is achieved.

In addition, regarding discharge tests carried under the same conditions, a discharging temperature comparison was made for continued charging (see Table 4).

Apart from the aforementioned tests carried out to compare charging and discharging with the addition and non-addition of the microelement structures, over-discharge tests were also recorded.

The first type of test was a forced load test for three months. (See Table 5)

A second type of test was a forced load test for six months. (see Table 6)

Based on these test data, the microelement structures 2 of the present invention were fabricated from structural materials containing microcontents of natural minerals. The microelement structures 2 containing mineral substances are able to produce vibration frequencies common to activated molecules similar to a high magnetic field, thereby modifying the molecular structure of the electrolyte to enable achieving an accelerated ion exchange rate, accelerated charging times, increased conversion rates, reduced accumulating blockage of lead sulfate crystals, reduced corrosion rate of the positive plates, and extended service life of the battery. In particular, the present invention further achieves the environmental objective of reducing polluting the earth, providing energy saving, and reducing carbon emissions.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A storage battery structure, comprising positive plates, negative plates, plates, a battery compartment, an electrolyte, and wiring portions; wherein the positive plates and the negative plates are respectively disposed on two sides of the plates, and a distance is preserved between an inner wall bottom portion of the battery compartment and the positive plates, the negative plates, and the plates; microelement structures are disposed in the bottom portion of the battery compartment, and each of the microelement structures is made up from a composition of granite, tourmaline, and a at least stone material, which are then mold casted and sintered at high temperature.

2. The storage battery structure according to claim 1, wherein the stone materials including coal, charcoal, malachite, zeolite, feldspar, meng moli pumice, limestone, gypsum, talcum powder, silver, or a combination of the above materials.
